(19) United States
(12) Patent Application Publication
(10) Pub. No.: US 2024/0020981 A1
(43) Pub. Date: Jan. 18, 2024

(54) INFORMATION PROCESSING APPARATUS AND METHOD

(71) Applicant: TOSHIBA TEC KABUSHIKI KAISHA, Tokyo (JP)

(72) Inventors: Takuya Kamitani, Mishima Shizuoka (JP); Yuishi Takeno, Numazu Shizuoka (JP)

(21) Appl. No.: 18/314,838

(22) Filed: May 10, 2023

(30) Foreign Application Priority Data
Jul. 13, 2022 (JP) 2022-112201

(51) Int. Cl. G06V 20/52; G06V 40/10; G06V 10/75; G06T 7/70

(52) U.S. Cl. CPC G06V 20/52; G06V 40/10; G06V 10/751; G06T 7/70

(57) ABSTRACT

A server apparatus (information processing apparatus) includes: an image acquisition unit configured to acquire an image captured by a camera (imaging device); a person detection unit configured to detect a person from the image acquired by the image acquisition unit; an object detection unit (abnormality detection unit) configured to detect an object separated from the person detected by the person detection unit; a distance calculation unit configured to calculate a distance between the person detected by the person detection unit and the object detected by the object detection unit; and a lost property determination unit configured to determine that, when the distance calculated by the distance calculation unit is equal to or greater than a threshold over a predetermined time or longer, the object is lost property.

### CROSS-REFERENCE TO RELATED APPLICATION

This application is based upon and claims the benefit of priority from Japanese Patent Application No. 2022-112201, filed on Jul. 13, 2022, the entire contents of which are incorporated herein by reference.

### FIELD

Embodiments described herein relate generally to an information processing apparatus and a method.

### BACKGROUND

In the related art, there has been known a left-behind object/lost property/lost article notification system in which an IC tag is attached to an object held by oneself, and when the object is lost, a signal from the IC tag is detected to notify an alarm device held by oneself.

In such a left-behind object/lost property/lost article notification system, since it is necessary to attach the IC tag to each held object, it takes time and effort. In addition, a case where an object without the IC tag being attached is lost cannot be notified. Therefore, an information processing apparatus capable of more easily detecting that an object is lost is desired.

### DESCRIPTION OF THE DRAWINGS

FIG. 1 is a block diagram showing an example of a schematic configuration of a lost property detection system according to an embodiment;

FIG. 2 is a hardware block diagram showing an example of a hardware configuration of a server apparatus;

FIG. 3 is a diagram showing an example of a flow of a lost property detection process performed by the server apparatus;

FIG. 4 is a diagram showing an example of a data structure of image data stored in the server apparatus;

FIG. 5 is a diagram showing an example of a data structure of person data;

FIG. 6 is a diagram showing an example of a data structure of object data;

FIG. 7 is a diagram showing an example of a data structure of lost property data;

FIG. 8 is a functional block diagram showing an example of a functional configuration of the server apparatus;

FIG. 9 is a flowchart showing an example of the flow of the lost property detection process; and

FIG. 10 is a flowchart showing an example of a flow of a lost property return process.

### DETAILED DESCRIPTION

In general, according to one embodiment, an information processing apparatus and a method that are capable of detecting that property is lost without attaching an identification unit such as an IC tag to the property are provided.

An information processing apparatus according to an embodiment includes an image acquisition unit, a person detection unit, an abnormality detection unit, a distance calculation unit, and a lost property determination unit. The image acquisition unit acquires an image captured by an imaging device. The person detection unit detects a person from the image acquired by the image acquisition unit. The abnormality detection unit detects an object separated from the person detected by the person detection unit. The distance calculation unit calculates a distance between the person detected by the person detection unit and the object detected by the abnormality detection unit. The lost property determination unit determines that, when the distance calculated by the distance calculation unit is equal to or greater than a threshold over a predetermined time or longer, the object is lost property.

An embodiment in which an information processing apparatus of an exemplary embodiment is applied to a lost property detection system 10 will be described with reference to the drawings. The lost property detection system 10 is provided inside a store, for example, and detects that a customer loses property in the store based on image data obtained by monitoring a state of a store inside.

Schematic Configuration of Lost Property Detection System

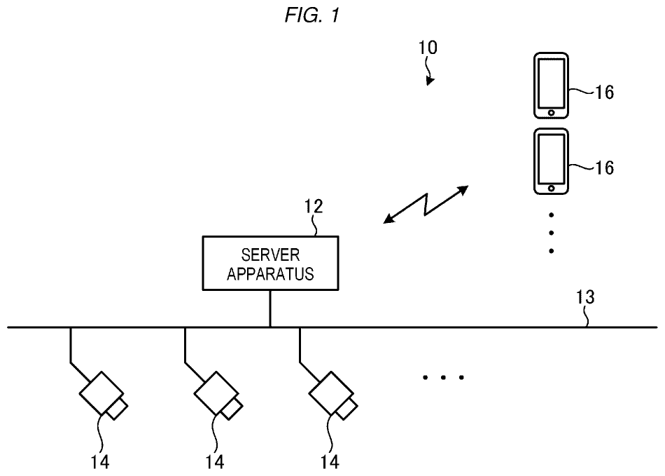

A schematic configuration of the lost property detection system 10 will be described with reference to FIG. 1. FIG. 1 is a block diagram showing an example of the schematic configuration of the lost property detection system according to the embodiment.

The lost property detection system 10 includes a server apparatus 12, a camera 14, and a mobile terminal 16.

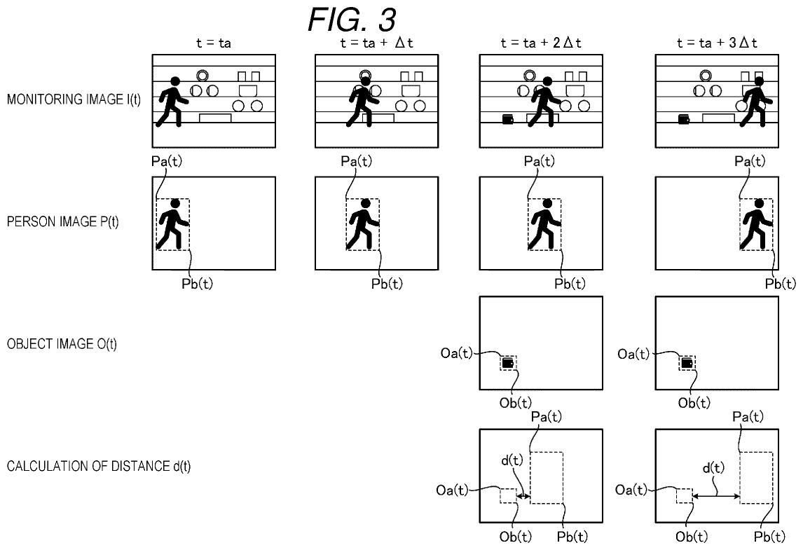

The server apparatus 12 receives monitoring images I(t) (see FIG. 3) captured by the camera 14 in time series. Then, the server apparatus 12 performs an image process on the received monitoring images I(t), and detects lost property and a person who loses the property. A specific detection method will be described later in detail (see FIG. 3). The server apparatus 12 is an example of an information processing apparatus disclosed herein.

For example, at least one camera 14 is provided in the store, and images the state of the store inside in time series. It is desirable that a plurality of cameras 14 are provided such that the state of the store inside can be imaged without a blind spot. An arrangement position of the camera 14 is not limited to the inside of the store, and the camera 14 may be provided outside the store. The camera 14 is an example of an imaging device disclosed herein. The camera 14 and the server apparatus 12 are connected by a local area network (LAN) 13 provided in the store, and an image captured by the camera 14 is transmitted to the server apparatus 12. The camera 14 and the server apparatus 12 may be wirelessly connected.

The mobile terminal 16 is carried by a salesclerk of the store, and receives, when the server apparatus 12 detects lost property, notification information for notifying that there is lost property. The mobile terminal 16 notifies the salesclerk that the notification information is received. The mobile terminal 16 is, for example, a smartphone or a tablet terminal.

Hardware Configuration of Server Apparatus

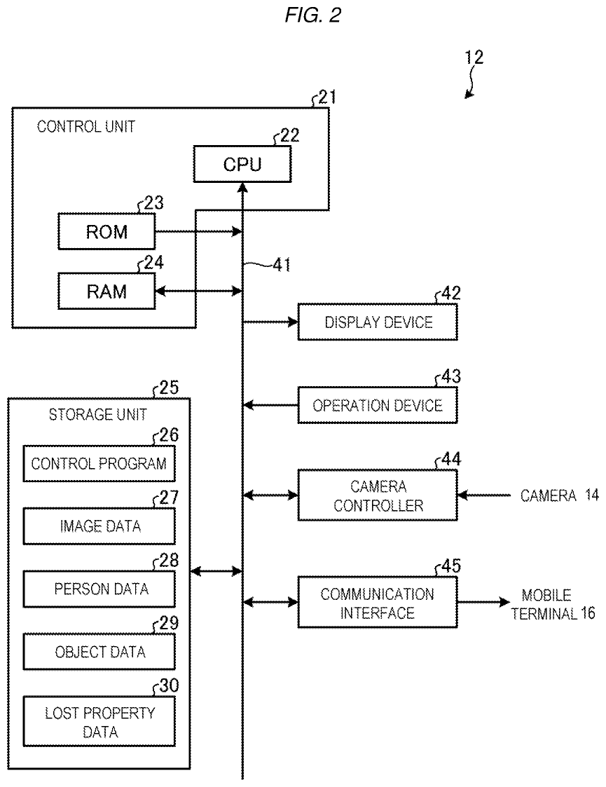

A hardware configuration of the server apparatus 12 will be described with reference to FIG. 2. FIG. 2 is a hardware block diagram showing an example of the hardware configuration of the server apparatus provided in the lost property detection system according to the embodiment.

The server apparatus 12 includes a control unit 21 that controls each unit of the server apparatus 12. The control unit 21 includes a central processing unit (CPU) 22, a read only memory (ROM) 23, and a random access memory (RAM) 24. The CPU 22 is connected to the ROM 23 and the RAM 24 via an internal bus 41 such as an address bus and a data bus. The CPU 22 loads various programs stored in the ROM 23 and a storage unit 25 into the RAM 24. The CPU 22 controls the server apparatus 12 by operating according to the various programs loaded in the RAM 24. That is, the control unit 21 has a configuration of a general computer.

The control unit 21 is connected to the storage unit 25, a display device 42, an operation device 43, a camera controller 44, and a communication interface 45 via the internal bus 41.

The storage unit 25 is a storage device such as a hard disk drive (HDD) or a solid state drive (SSD). The storage unit 25 may be a nonvolatile memory such as a flash memory in which stored information is held even when power is turned off. The storage unit 25 stores a control program 26, image data 27, person data 28, object data 29, and lost property data 30.

The control program 26 is a program for controlling an overall operation of the server apparatus 12.

The control program 26 may be provided by being incorporated in the ROM 23 in advance. The control program 26 may be provided by being recorded in a computer-readable recording medium such as a CD-ROM, a flexible disk (FD), a CD-R, or a digital versatile disk (DVD) as a file in an installable format or an executable format in the control unit 21. Further, the control program 26 may be stored in a computer connected to a network such as the Internet and may be provided by being downloaded via the network. The control program 26 may be provided or distributed via a network such as the Internet.

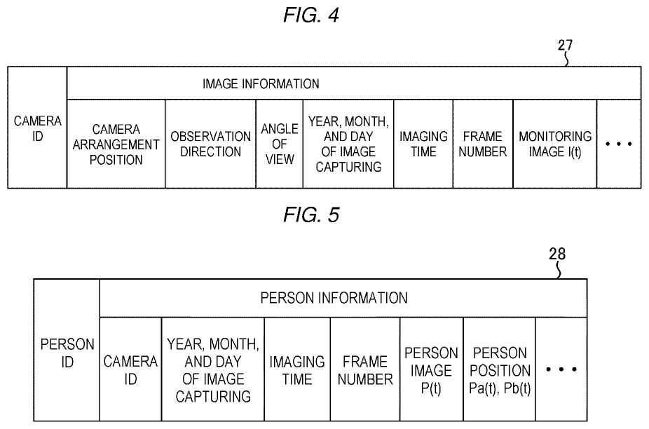

In the image data 27, the monitoring images I(t) (see FIG. 3) captured by the camera 14 are stored. A detailed data structure of the image data 27 will be described later (see FIG. 4).

In the person data 28, person images P(t) (see FIG. 3) indicating a person detected from the monitoring images I(t) are stored. A detailed data structure of the person data 28 will be described later (see FIG. 5).

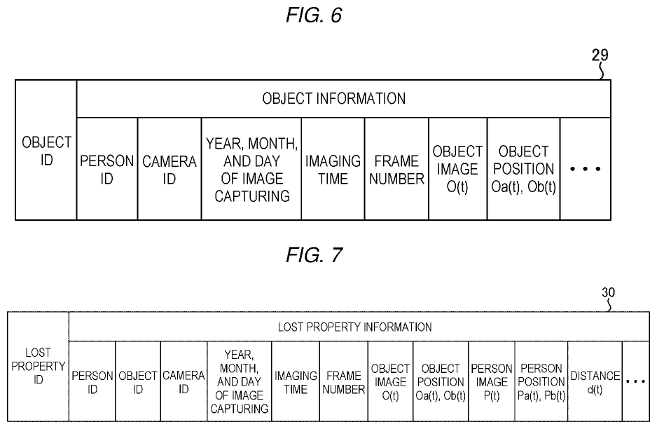

In the object data 29, object images O(t) (see FIG. 3) indicating an object that is separated from the person image P(t) are stored. A detailed data structure of the object data 29 will be described later (see FIG. 6).

In the lost property data 30, information related to the lost property detected by the server apparatus 12 is stored. A detailed data structure of the lost property data 30 will be described later (see FIG. 7).

The display device 42 is an output device that displays image information and text information that are generated by the server apparatus 12. The display device 42 is, for example, a liquid crystal monitor or an organic EL monitor.

The operation device 43 is an input device through which an operator of the server apparatus 12 inputs various operation instructions to the server apparatus 12. The operation device 43 is, for example, a touch panel or a keyboard.

The camera controller 44 is an interface device for the server apparatus 12 to acquire the monitoring images I(t) captured by the camera 14.

The communication interface 45 is an interface device that controls communication between the server apparatus 12 and the mobile terminal 16.

Flow of Lost Property Detection Process

A flow of the lost property detection process performed by the server apparatus 12 will be described with reference to FIG. 3. FIG. 3 is a diagram showing an example of the flow of the lost property detection process performed by the server apparatus.

In order to simplify the description, a case where a person in the store is monitored by one camera 14 will be described as an example. At this time, it is assumed that the server apparatus 12 acquires four monitoring images I(ta), I(ta+Δt), I(ta+2Δt), and I(ta+3Δt) shown in FIG. 3 from the camera 14.

The server apparatus 12 performs a person detection process of detecting a person from each monitoring image. The person detection process can be performed using a known skeleton detection method in which deep learning is used. Specifically, for example, a technique, referred to as pose estimation, of detecting skeleton data of a person can be utilized. By performing the person detection process, a person is detected from the series of monitoring images I(t), and a position thereof is identified. The position of the person is represented by an upper left coordinate Pa(t) and a lower right coordinate Pb(t) of a rectangular region including the person or a skeleton. By performing such a person detection process, person images P(ta), P(ta+Δt), P(ta+2Δt), and P(ta+3Δt) shown in FIG. 3 are obtained.

Further, the server apparatus 12 determines whether the persons detected from the monitoring images I(t) are the same person, and performs a person tracking process of tracking a position where the same person is present. The person tracking process can be implemented by, for example, performing image classification in which the deep learning is used. Specifically, for example, by using a convolutional layer of a convolutional neural network (CNN) as a feature extractor, at least one piece of feature data of the person is extracted. Then, by comparing pieces of the feature data extracted from different images with each other using a nearest neighbor method or the like, whether the persons are the same person can be determined.

Next, the server apparatus 12 performs an object detection process of detecting whether there is an object that is separated from the tracked person. The object detection process can be performed by known motion recognition in which the deep learning is used. Specifically, the server apparatus 12 generates a network by performing machine learning on each of a moving image when a person loses an object and a moving image when the person performs other motions. By inputting a moving image obtained by tracking the same person to the network generated in such a manner, it is possible to recognize that the object is separated from the person. Such an object detection process can be implemented using, for example, Slow-Fast, which is one of motion detection methods. By performing the object detection process, an object is detected from the series of person images P(t), and a position thereof is identified. The position of the object is represented by an upper left coordinate Oa(t) and a lower right coordinate Ob(t) of a rectangular region including the object. By performing such an object detection process, object images O(ta+2Δt) and O(ta+3Δt) shown in FIG. 3 are obtained. Since the position of the object that is separated from the person is generally not changed over time, coordinates Oa(ta+2Δt) and Ob(ta+2Δt) in the object image O(ta+2Δt) are equal to coordinates Oa(ta+3Δt) and Ob(ta+3Δt) in the object image O(ta+3Δt).

In a store, a motion of returning a commodity taken by a hand of a customer at once to a commodity shelf is often seen. Since such a motion is not a motion of losing an object, it is necessary to distinguish the motion. Therefore, the motion of returning a commodity taken by a hand at once to a commodity shelf may also be subjected to the machine learning, and the motion may be recognized by being distinguished from the motion of losing an object.

Further, the server apparatus 12 calculates a distance between the detected object and the person from whom the object is separated. The distance between the object and the person is, for example, a distance d(t) between the rectangular region including the object and the rectangular region including the person as shown in FIG. 3. In the example in FIG. 3, the distance d(t) at a time t=ta+3Δt is larger than the distance d(t) at a time t=ta+2Δt.

When the distance d(t) calculated in such a manner is equal to or greater than a threshold over a predetermined time, the server apparatus 12 determines that the object is lost property.

Data Structure of Image Data

A data structure of the image data 27 will be described with reference to FIG. 4. FIG. 4 is a diagram showing an example of the data structure of the image data stored in the server apparatus.

As shown in FIG. 4, in the image data 27, a camera ID that uniquely identifies the camera 14, the monitoring image I(t) captured by the camera 14 having the corresponding camera ID, and additional information are stored and associated with one another.

The additional information includes the arrangement position of the camera 14 of the corresponding camera ID, an observation direction having the corresponding camera 14, an angle of view, a year, month, and day when the monitoring image I(t) is captured, an imaging time, and a frame number.

Data Structure of Person Data

A data structure of the person data 28 will be described with reference to FIG. 5. FIG. 5 is a diagram showing an example of the data structure of the person data stored in the server apparatus.

In the person data 28, a person ID for identifying a person detected by the process described with reference to FIG. 3, the person image P(t) indicating a detection result of the corresponding person, the coordinates Pa(t), Pb(t) which are the person position in the person image P(t), and additional information are stored and associated with one another.

The additional information includes a camera ID of a camera capturing the monitoring image I(t) in which the person image P(t) is detected, a year, month, and day when the monitoring image I(t) is captured in which the person image P(t) is detected, an imaging time, and a frame number.

Data Structure of Object Data

A data structure of the object data 29 will be described with reference to FIG. 6. FIG. 6 is a diagram showing an example of the data structure of the object data stored in the server apparatus.

In the object data 29, an object ID for identifying an object detected by the process described in FIG. 3, the object image O(t) indicating a detection result of the corresponding object, the object position Oa(t), Ob(t) in the object image O(t), and additional information are stored and associated with one another.

The additional information includes a person ID indicating the person from whom the object is separated, a camera ID of a camera capturing the monitoring image I(t) in which the object separated from the person having the person ID is detected, a year, month, and day when the monitoring image I(t) is captured in which the separated object is detected, an imaging time, and a frame number.

Data Structure of Lost Property Data

A data structure of the lost property data 30 will be described with reference to FIG. 7. FIG. 7 is a diagram showing an example of the data structure of the lost property data stored in the server apparatus.

In the lost property data 30, a lost property ID for identifying lost property detected by the process described with reference to FIG. 3, the object image O(t) indicating a detection result of the object determined as the lost property, the object position Oa(t), Ob(t) in the corresponding object image O(t), the person image P(t) indicating a detection result of the person determined as the person from whom the object is separated, the coordinates Pa(t), Pb(t) which are the person position in the corresponding person image P(t), the distance d(t) between the object and the person, and additional information are stored and associated with one another.

The additional information includes a person ID for identifying the person from whom the object is separated, an object ID for identifying an object corresponding to the lost property, a camera ID for identifying the camera 14 capturing the monitoring image I(t) in which the person having the person ID from whom the object is separated is detected, a year, month, and day when the monitoring image I(t) is captured based on which the object is determined as the lost property, an imaging time, and a frame number.

As described above, the image data 27, the person data 28, the object data 29, and the lost property data 30 are associated with one another via the camera ID, the person ID, and the object ID. Accordingly, it is possible to easily refer to the monitoring image I(t) in which the person is detected, the monitoring image I(t) in which the object is detected, and the monitoring image I(t) in which it is determined that there is lost property.

Functional Configuration of Server Apparatus

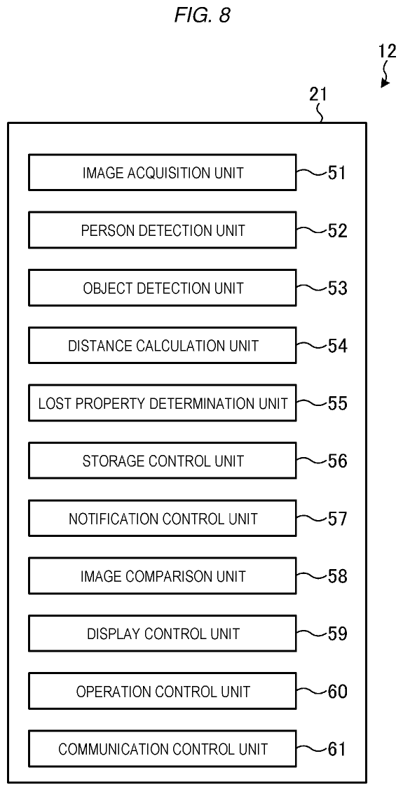

A functional configuration of the server apparatus 12 will be described with reference to FIG. 8. FIG. 8 is a functional block diagram showing an example of the functional configuration of the server apparatus provided in the lost property detection system according to the embodiment.

The control unit 21 of the server apparatus 12 loads the control program 26 into the RAM 24 and operates the control program 26, thereby implementing an image acquisition unit 51, a person detection unit 52, an object detection unit 53, a distance calculation unit 54, a lost property determination unit 55, a storage control unit 56, a notification control unit 57, an image comparison unit 58, a display control unit 59, an operation control unit 60, and a communication control unit 61 shown in FIG. 8 as functional units. A part or all of these functions may be implemented by dedicated hardware.

The image acquisition unit 51 acquires the monitoring image I(t) captured by the camera 14 (imaging device) provided in the store.

The person detection unit 52 detects a person from the monitoring image I(t) acquired by the image acquisition unit 51. The person detection unit 52 tracks the same person as the previously detected person in a monitoring image captured at a time different from that of the monitoring image I(t).

The object detection unit 53 detects an object that is separated from the person detected by the person detection unit 52. The object detection unit 53 is an example of an abnormality detection unit disclosed herein.

The distance calculation unit 54 calculates the distance d(t) between the person detected by the person detection unit 52 and the object detected by the object detection unit 53.

When the distance d(t) calculated by the distance calculation unit 54 is equal to or greater than the threshold over the predetermined time or longer, the lost property determination unit 55 determines that the object detected by the object detection unit 53 is lost property.

The storage control unit 56 associates an image indicating the person detected by the person detection unit 52, an image indicating the object that is separated from the person, and a position of the corresponding object with one another, and stores the associated information in the storage unit 25 (storage device).

The notification control unit 57 performs a notification under a condition that the lost property determination unit 55 determines that there is lost property. More specifically, the notification control unit 57 transmits information indicating that there is lost property and a certain position of the corresponding lost property to the mobile terminal 16 under the condition that the lost property determination unit 55 determines that there is lost property. When the mobile terminal 16 receives the information related to the lost property from the server apparatus 12, the mobile terminal 16 notifies that there is lost property by image display, audio output, or the like. In addition, the mobile terminal 16 displays the certain position of the lost property. The notification control unit 57 is an example of a notification unit disclosed herein.

When an owner of the lost property appears, the image comparison unit 58 compares an image obtained by imaging the owner and the person image P(t) related to the corresponding lost property, thereby determining whether the persons are the same person.

The display control unit 59 generates display information such as image data to be displayed on the display device 42 connected to the server apparatus 12. The display control unit 59 causes the display device 42 to display the generated display information.

The operation control unit 60 acquires operation information of an operator for the operation device 43 connected to the server apparatus 12. The operation control unit 60 transfers the acquired operation information to the control unit 21.

The communication control unit 61 controls communication between the server apparatus 12 and the mobile terminal 16.

Flow of Lost Property Detection Process Performed by Server Apparatus

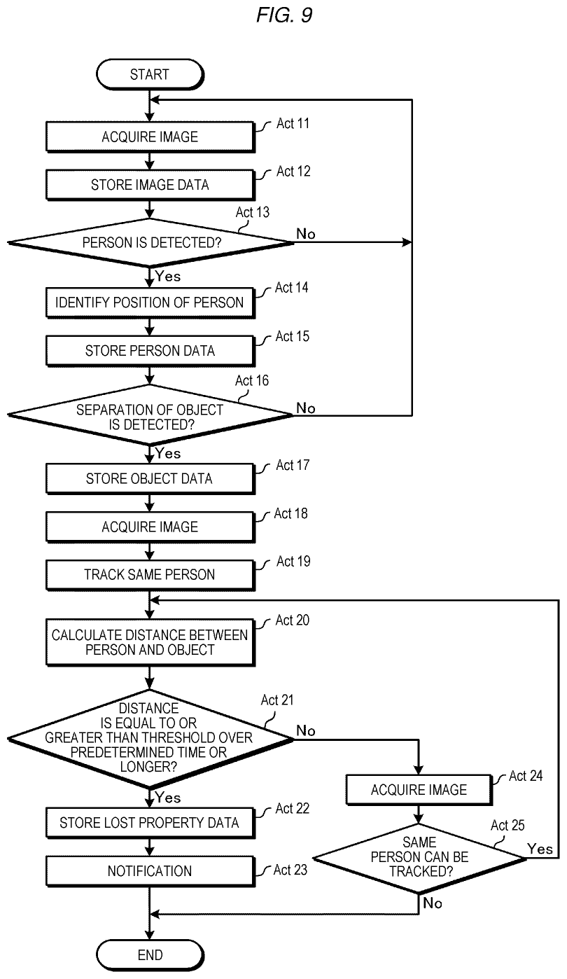

A flow of the lost property detection process performed by the server apparatus 12 will be described with reference to FIG. 9. FIG. 9 is a flowchart showing an example of the flow of the lost property detection process performed by the server apparatus according to the embodiment.

The image acquisition unit 51 acquires the monitoring image I(t) from the camera 14 (Act 11).

The storage control unit 56 stores the acquired monitoring image I(t) as the image data 27 in the storage unit 25 (Act 12).

The person detection unit 52 performs the person detection process on the monitoring image I(t) and determines whether a person is detected (Act 13). If it is determined that a person is detected (Act 13: Yes), the process proceeds to Act 14. On the other hand, If it is determined that a person is not detected (Act 13: No), the process returns to Act 11.

In Act 13, If it is determined that a person is detected, the person detection unit 52 identifies a position (coordinates Pa(t), Pb(t)) of the person (Act 14).

The storage control unit 56 stores the person image P(t) including the detection result and the position of the person as the person data 28 in the storage unit 25 (Act 15).

The object detection unit 53 performs the object detection process of detecting the separation of the object from the detected person, and determines whether the separation of the object is detected (Act 16). If it is determined that the separation of the object is detected (Act 16: Yes), the process proceeds to Act 17. On the other hand, if it is determined that the separation of the object is not detected (Act 16: No), the process returns to Act 11.

If it is determined in Act 16 that the separation of the object is detected, the storage control unit 56 stores the object image O(t) including the detection result and a position of the object as the object data 29 in the storage unit 25 (Act 17).

The image acquisition unit 51 acquires the monitoring image I(t) from the camera 14 (Act 18).

The person detection unit 52 tracks the previously detected person from the latest monitoring image I(t) (Act 19).

The distance calculation unit 54 calculates the distance d(t) between the person and the object separated from the corresponding person (Act 20).

The lost property determination unit 55 determines whether the distance d(t) is equal to or greater than a threshold over a predetermined time or longer (Act 21). If it is determined that the distance d(t) is equal to or greater than the threshold over the predetermined time or longer (Act 21: Yes), the process proceeds to Act 22. On the other hand, if it is determined that the distance d(t) is smaller than the threshold over the predetermined time or longer (Act 21: Yes), the process proceeds to Act 24.

In Act 21, if it is determined that the distance d(t) is equal to or greater than the threshold over the predetermined time or longer, the lost property determination unit 55 determines that the focused object is the lost property of the person from whom the object is separated. Then, the storage control unit 56 stores the object image O(t) including the detection result and the position of the focused object and the person image P(t) including the detection result and the position of the person from whom the object is separated in the storage unit as the lost property data 30 (Act 22).

The notification control unit 57 notifies the mobile terminal 16 that there is lost property (Act 23). Thereafter, the server apparatus 12 ends the process in FIG. 9.

On the other hand, if it is determined in Act 21 that the distance d(t) is smaller than the threshold over the predetermined time or longer, the image acquisition unit 51 acquires the monitoring image I(t) from the camera 14 (Act 24).

The person detection unit 52 determines whether the same person can be tracked in the monitoring image I(t) (Act 25). If it is determined that the same person can be tracked (Act 25: Yes), the process returns to Act 20. On the other hand, when it is determined that the same person cannot be tracked (Act 25: No), the server apparatus 12 ends the process in FIG. 9.

Flow of Lost Property Return Process Performed by Server Apparatus

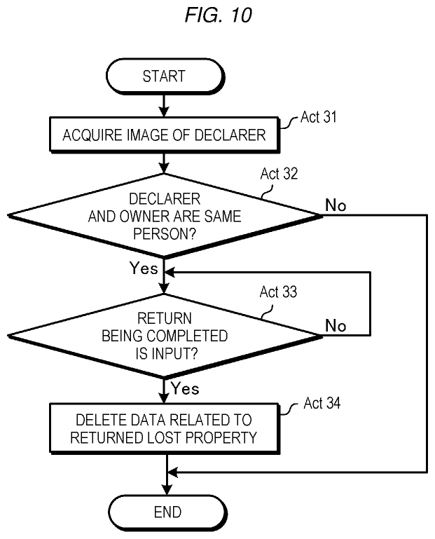

A flow of the lost property return process performed by the server apparatus 12 will be described with reference to FIG. 10. FIG. 10 is a flowchart showing an example of the flow of the lost property return process performed by the server apparatus according to the embodiment.

The image acquisition unit 51 acquires an image of a declarer (Act 31).

The image comparison unit 58 determines whether the declarer and the owner of the lost property are the same person (Act 32). The operator of the server apparatus 12 identifies the lost property based on a declaration of the declarer. Then, the person image P(t) of the owner of the lost property is acquired from the lost property data 30 related to the identified lost property. Then, the image comparison unit 58 compares the acquired person image P(t) with the image of the declarer acquired in Act 31. If it is determined that the declarer and the owner of the lost property are the same person (Act 32: Yes), the process proceeds to Act 33. On the other hand, if it is determined that the declarer and the owner of the lost property are not the same person (Act 32: No), the server apparatus 12 ends the process in FIG. 10.

If it is determined in Act 32 that the declarer and the owner of the lost property are the same person, the operation control unit 60 determines whether information indicating that return of the lost property is completed is received (Act 33). If it is determined that the information indicating that the return of the lost property is completed is received (Act 33: Yes), the process proceeds to Act 34. On the other hand, if it is determined that the information indicating that the return of the lost property is completed is not received (Act 33: No), Act 33 is repeated.

If it is determined in Act 33 that the information indicating that the return of the lost property is completed is received, the storage control unit 56 deletes the data related to the returned lost property from the lost property data 30 (Act 34). At this time, the storage control unit 56 may delete data related to the returned lost property and the owner of the lost property from the image data 27, the person data 28, and the object data 29. Thereafter, the server apparatus 12 ends the process in FIG. 10.

### Effect of Embodiment

As described above, the server apparatus 12 (information processing apparatus) according to the present embodiment includes: the image acquisition unit 51 that acquires the monitoring image I(t) captured by the camera 14 (imaging device); the person detection unit 52 that detects a person from the image acquired by the image acquisition unit 51; the object detection unit 53 (abnormality detection unit) that detects an object that is separated from the person detected by the person detection unit 52; the distance calculation unit 54 that calculates the distance d(t) between the person detected by the person detection unit 52 and the object detected by the object detection unit 53; and the lost property determination unit that determines, when the distance d(t) calculated by the distance calculation unit 54 is equal to or greater than the threshold over the predetermined time or longer, the object is lost property. Accordingly, it is possible to detect that property is lost without attaching an identification unit such as an IC tag to the property.

The server apparatus 12 (information processing apparatus) according to the present embodiment further includes: the storage control unit 56 that associates the person image P(t) indicating the person detected by the person detection unit 52, the object image O(t) indicating the object that is separated from the person, and the position Oa(t), Ob(t) of the object with one another, and that stores the associated information in the storage unit 25 (storage device). Accordingly, it is possible to easily and reliably determine whether the object separated from the person is lost property.

The server apparatus 12 (information processing apparatus) according to the present embodiment further includes: the notification control unit 57 that performs the notification under the condition that the lost property determination unit 55 determines that there is lost property. Accordingly, it is possible to immediately notify that lost property is detected.

In the server apparatus 12 (information processing apparatus) according to the present embodiment, the storage control unit 56 deletes the information related to the lost property from the storage unit 25 (storage device) under a condition that the information indicating that the lost property is returned to the owner is received. Accordingly, storage contents of the storage device can be managed without taking time and effort.

The server apparatus 12 (information processing apparatus) according to the present embodiment further includes: the image comparison unit 58 that compares the image indicating the person detected by the person detection unit 52 with the image of the declarer who makes a declaration that the declarer is the owner of the lost property, and the lost property determination unit 55 determines that the declarer is the owner under a condition that the images of the persons compared by the image comparison unit 58 match. Accordingly, it is possible to easily and reliably determine whether the person who makes the declaration that the person is the owner is a correct owner.

The embodiments of the invention are described above, but these embodiments are presented as examples, and are not intended to limit the scope of the invention. These novel embodiments can be implemented in various other forms, and various omissions, substitutions, and modifications may be made without departing from the spirit of the exemplary embodiments. The embodiments and modifications are included in the scope and the gist of the embodiment, and included in the inventions described in the claims and the scope of equivalents of the inventions.

What is claimed is:

1. An information processing apparatus, comprising:
an image acquisition component configured to acquire an image captured by an imaging device;
a person detector configured to detect a person from the image acquired by the image acquisition component;
an abnormality detector configured to detect an object separated from the person detected by the person detector;
a distance calculation component configured to calculate a distance between the person detected by the person detector and the object detected by the abnormality detector; and
a lost property determination component configured to determine that, when the distance calculated by the distance calculation component is equal to or greater than a threshold over a predetermined time or longer, the object is lost property.

2. The information processing apparatus according to claim 1, further comprising:
a storage controller configured to associate an image indicating the person detected by the person detector, an image indicating the object that is separated from the person, and a position of the object with one another, and to store the associated information in a storage device.

3. The information processing apparatus according to claim 1, further comprising:
a notification component configured to perform a notification under a condition that the lost property determination component determines that there is lost property.

4. The information processing apparatus according to claim 2, wherein
the storage controller deletes information related to the lost property from the storage device under a condition that information indicating that the lost property is returned to an owner is received.

5. The information processing apparatus according to claim 1, further comprising:
an image comparison component configured to compare an image indicating the person detected by the person detector with an image of a declarer who makes a declaration that the declarer is an owner of the lost property, wherein
the lost property determination component determines that the declarer is the owner under a condition that the images of the persons compared by the image comparison component match.

6. The information processing apparatus according to claim 1, wherein the abnormality detector is further configured to record a date and time of detection of the object separated from the person detected by the person detector.

7. An information processing method, comprising:
acquiring an image captured by an imaging device;
detecting a person from the acquired image;
detecting an object separated from the detected person;
calculating a distance between the detected person and the detected object; and
determining that, when the calculated distance is equal to or greater than a threshold over a predetermined time or longer, the object is lost property.

8. The information processing method according to claim 7, further comprising:
associating an image indicating the person detected, an image indicating the object that is separated from the person, and a position of the object with one another; and
storing the associated information in a storage device.

9. The information processing method according to claim 7, further comprising:
notifying under a condition that a determination that there is lost property is made.

10. The information processing method according to claim 8, further comprising:
deleting information related to the lost property from the storage device under a condition that information indicating that the lost property is returned to an owner is received.

11. The information processing method according to claim 7, further comprising:
comparing an image indicating the person detected with an image of a declarer who makes a declaration that the declarer is an owner of the lost property; and
determining that the declarer is the owner under a condition that the images of the persons compared match.

12. The information processing method according to claim 7, further comprising:
recording a date and time of detection of the object separated from the person detected.

13. A point of sale terminal, comprising:
a registration component;
a settlement component;
an image acquisition component configured to acquire an image captured by an imaging device;
a person detector configured to detect a person from the image acquired by the image acquisition component;
an abnormality detector configured to detect an object separated from the person detected by the person detector;
a distance calculation component configured to calculate a distance between the person detected by the person detector and the object detected by the abnormality detector; and
a lost property determination component configured to determine that, when the distance calculated by the distance calculation component is equal to or greater than a threshold over a predetermined time or longer, the object is lost property.

14. The point of sale terminal according to claim 13, further comprising:
a storage controller configured to associate an image indicating the person detected by the person detector, an image indicating the object that is separated from the person, and a position of the object with one another, and to store the associated information in a storage device.

15. The point of sale terminal according to claim 13, further comprising:
a notification component configured to perform a notification under a condition that the lost property determination component determines that there is lost property.

16. The point of sale terminal according to claim 14, wherein
the storage controller deletes information related to the lost property from the storage device under a condition that information indicating that the lost property is returned to an owner is received.

17. The point of sale terminal according to claim 13, further comprising:
an image comparison component configured to compare an image indicating the person detected by the person detector with an image of a declarer who makes a declaration that the declarer is an owner of the lost property, wherein
the lost property determination component determines that the declarer is the owner under a condition that the images of the persons compared by the image comparison component match.

18. The point of sale terminal according to claim 13, wherein the abnormality detector is further configured to record a date and time of detection of the object separated from the person detected by the person detector.
